(19) United States
(12) Patent Application Publication
(10) Pub. No.: US 2026/0066566 A1
(43) Pub. Date: Mar. 5, 2026

(54) CONTACT ELEMENT, CURRENT COLLECTOR, CONTACT STATION, CONTACT CHARGING SYSTEM AND INSTALLATION

(71) Applicant: Conductix-Wampfler GmbH, Weil am Rhein (DE)

(72) Inventors: Moritz HAGIN, Weil am Rhein (DE); Dietmar LANG, Schliengen (DE)

(73) Assignee: Conductix-Wampfler GmbH, Weil am Rhein (DE)

(21) Appl. No.: 19/311,133

(22) Filed: Aug. 27, 2025

(30) Foreign Application Priority Data
Aug. 29, 2024 (DE) 10 2024 124 775.4

(51) Int. Cl. H01R 13/24; H01R 4/48; H01R 13/642; H01R 41/00

(52) U.S. Cl. CPC H01R 13/2407; H01R 4/4811; H01R 13/2471; H01R 13/2492; H01R 13/642; H01R 41/00

(57) ABSTRACT

A contact element for contacting a sliding contact has a fastening section and a contact section connected thereto and extending in a longitudinal direction. The sliding contact and the contact element are movable relative to each other. The problem of enabling an improved, safe, reliable and low-wear conductive transmission electrical energy and/or data to and/or from a movable electrical consumer is addressed in that the contact section has at least one electrically conductive contact with a contact surface for electrically conductive contacting of the sliding contact. A current collector transmits electrical energy and/or data to or from a contact station has at least one such contact element. The contact station has one or more sliding contacts for contacting one or more contact elements of the current collector.

### FIELD OF THE INVENTION

The invention relates to a contact element, a current collector, a contact station, a contact charging system, as well as an installation.

### BACKGROUND

DE 10 2019 131 365 A1 relates to a warehouse with at least one shelf arrangement in which freight can be stored and from which freight can be retrieved by means of a forklift, and with a passage running along the shelf arrangement, in which an inductive charging device is provided for the forklift situated in the passage, wherein the inductive charging device has a first distance on its side facing the shelf arrangement and a second distance on its side facing away from the shelf arrangement, wherein the first distance is dimensioned such that the forklift can be inductively charged during an entry and exit process and the second spacing being dimensioned so that the forklift can be inductively charged during a lifting and lowering process. Since inductive charging entails a significant expense, the distance between the transmission coils must be kept as small as possible or the transmission power must be increased in order to be able to conduct charging quickly and safely. Health problems can also occur among operating personnel owing to the relatively high magnetic fields, and electronic devices, such as cell phones or operating equipment wirelessly connected to a data network can be adversely affected.

US 2023/0278797 A1 discloses a block storage arrangement and a method for operating same. The block storage arrangement includes several container stacking compartments, a storage compartment arranged beneath them, at least one storage vehicle movable therein, with which containers can be introduced into a container stacking compartment from below and/or removed from the container stacking compartment from below, which has an electric drive device and an electrically chargeable battery, and at least one transfer station in which an electrical charging device for the battery is arranged.

U.S. Pat. No. 5,998,963 A relates to a service center and a method intended to promote the use of a battery-operated electric vehicle. They enable easy and rapid replacement of a discharged battery in the electric vehicle and the subsequent recharging thereof for use in another electric vehicle. The service center and method use a number of universally adaptable batteries that can be used in most battery-operated electric vehicles. The batteries are designed to be lifted into or lowered from a battery receiving space on the bottom of an electric vehicle. During use, the electric vehicles are driven into a service center. The batteries are removed from the vehicle and then conveniently transported to a charging unit in the adjacent charging center. A second charged battery is then removed from the charging unit and transported to the electric vehicle, installed therein and locked. As a result, the heavy electric battery can be easily handled and the long waiting time for charging the battery is eliminated, thus enabling the electric vehicle to travel unlimited distances.

US 2019/0148891 A1 relates to various configurations of active cover plates with pins that are configured for contact with side screw terminals of electrical sockets.

DE 10 2008 042 050 A1 discloses an electrical power-plug contact for supplying voltage and/or current to electrical components in a vehicle, with a conductor contact surface for contacting an electric cable and with spring elements for generating a pressure force oriented perpendicular to a plug-in direction, and with a locking spring for preventing the power-plug contact from being removed against the plug-in direction. Provision is made here for a contact area to be provided for direct contacting of a conductor track of a printed circuit board. The invention also relates a circuit board arrangement.

US 2004/0121629 A1 discloses an electronic card connector comprising an insulating housing, a plurality of conductive terminals and a plurality of terminal passageways that penetrate the insulating housing from the top down. The conductive terminals can each be accommodated in corresponding terminal passageways. In addition to a base section, each conductive terminal includes a soldering tail and a contact section, and they are each arranged on opposite ends of the conductive terminal. Receiving recesses are formed at the bottom of the insulating housing to receive the soldering tail. Interference sections are formed on the inside walls of the recesses for receiving the soldering tails. An elevated platform is formed at the center of each recess, against which the soldering tail is pressed. An approximately U-shaped slot is formed between two adjacent receiving recesses in order to increase the holding force of the interference section against the soldering tail.

### SUMMARY OF THE INVENTION

One aspect of the invention relates to improved, safe, reliable and low-wear conductive transmission of electrical energy and/or data to and/or from a movable electrical consumer.

The invention addresses this problem with a contact element, a current collector, a contact station, a contact charging system, as well as an installation, in particular a high-bay warehouse.

The contact element mentioned above is characterized according to the invention in that the contact section has at least one electrically conductive contact with a contact surface for electrically conductive contacting of the sliding contact.

Preferably, the contact section can be electrically conductive. Furthermore, the contact section can advantageously be curved convexly. This ensures that at least one of the contacts can establish a good electrical connection with the sliding contact.

The contact section can also advantageously have trough-like side walls at least partially facing away from the contact surface. The stability of the contact section can be improved by the trough-like configuration, which is particularly helpful with respect to the desired number of contacting cycles. The trough-like side walls can run essentially in the longitudinal direction.

The contact section can preferably have a free end. Mobility of the contact section, in particular in the height direction, can thus be improved. The contact section can also preferably taper toward the free end.

The fastening section can also preferably run in the longitudinal direction. The fastening section can also advantageously have positioning recesses and/or positioning protrusions running in the transverse direction across the longitudinal direction. Positioning and fixation of the contact element in the current collector can thereby be facilitated, particularly in the longitudinal direction and in a transverse direction running perpendicular thereto, which preferably also runs perpendicular to the height direction, which in turn preferably runs perpendicular to the longitudinal direction.

A sharply curved section, preferably by at least 150°, with particular preference by at least 170°, can be connected to the fastening section in the longitudinal direction. This curved section can preferably be designed U-shaped.

The contact section can also be positioned in a rest position relative to the fastening section, and, during deflection of the contact section from the rest position, a restoring element exerts an especially spring-elastic restoring force on the contact section in the direction of the rest position.

In the configuration of the sharply curved section described above, particularly the U-shaped configuration, the fastening section and the contact section can advantageously be arranged one above the other, in which the sharply curved section then likewise acts as a spring-elastic restoring element, which produces the restoring force of the contact section to the rest position as well as to the fastening section in cooperation with the contact section of the fastening section. However, a spring element can also be directly provided as the restoring element between the fastening section and the contact section, for example, one or more coil springs, or a leaf spring or the like.

A first curved section can preferably be connected to the contact section in the longitudinal direction. The first curved section can then advantageously be curved in the opposite direction to the contact section in the height direction, so that the first curved section and the contact section form an approximately S-shaped curved section. The first curved section can also preferably taper toward the contact section. The first curved section can preferably be connected to the sharply curved section in the longitudinal direction.

The contact surface of the contact can preferably be designed cap-like, especially in the form of a spherical cap. Particularly good electrical contact with a clearly spatially defined contact point can thereby be achieved. This is also the case when the contact section is inclined or tilted relative to the sliding contact, when viewed in the longitudinal direction, since even then a clearly defined contact point of the contact surface lies on the sliding contact.

The contact can then preferably have a contact part with a contact surface, in particular a mushroom-shaped contact part. The contact can also advantageously have a fastening part for fastening into a correspondingly shaped contact receptacle of the contact section. Several contacts offset relative to each other in the longitudinal direction can also be fastened on the contact section, which are preferably identical in design. This ensures electrical contact even when the contact element is moved toward and/or away from the sliding contact, and also compensates for any tilting of the contact element in the longitudinal direction.

The contacts can then preferably follow the course of the contact section in the longitudinal direction, in particular its curvature or bend, and/or be arranged at an angle relative to each other in the height direction.

In an advantageous embodiment, the vertices of the contact surfaces follow the curvature of the contact section and/or the vertices lie on a circular arc. Good and point-precise transmission can thus be achieved between the contact surfaces and the sliding contact and in particular the contact of the contact surfaces against the sliding contact can be improved, regardless of the position of the contact section relative to the sliding contact during operation. The contacts can advantageously be designed as contact pins.

Several or all of the offset contacts can preferably be electrically connected to each other and/or mechanically connected to a contact pin element. Manufacture of the contact element can thus be simplified, since the contacts then no longer need to be inserted individually into the contact section and fastened; instead, the contact pin element can be incorporated in a single step.

The contact pin element can advantageously be adapted to the curvature of the contact section so that good electrical contact with the contact section can be achieved.

The contacts can preferably be connected to each other via connectors.

The connectors can also advantageously have current transmission surfaces facing the contact section, for preferably flat surface contact against the contact section. High current transmission between the contacts and the contact section can thereby be achieved while maintaining a compact design.

An advantageous variant in terms of manufacture can provide for the contact pin element to be made in one piece with the contacts.

A current collector mentioned in the introduction for the conductive transmission of electrical energy and/or data to and from a contact station is characterized according to the invention in that it has at least one contact element as described in the claims as well as above and below.

The contact elements can preferably be arranged parallel to each other across the longitudinal direction. The contact elements can also preferably be positioned floating on the current collector, in particular floating in the longitudinal direction and/or the height direction and/or a transverse direction across the longitudinal direction and/or across the height direction.

The contact elements can also preferably be arranged on a support plate of the current collector, in which case separators can be provided between the contact elements, in particular electrically insulating separators. The support plate can advantageously be assembled from individual parts, in particular sections running in the longitudinal direction and connectable to each other in the transverse direction. This facilitates assembly of the collector.

A contact station mentioned in the introduction for conductive transmission of electrical energy and/or data to or from a current collector is characterized according to the invention in that the contact station has one or more sliding contacts for contacting one or more contact elements of the current collector described in the claims as well as above and below.

The contact station can preferably have one or more sliding contacts for contacting one or more contact elements of the current collector. The sliding contact or contacts can also preferably have ramp-like ends running in the height direction opposite each other in the longitudinal direction. These facilitate entry or exit of the contact elements, which are first slowly deflected from the rest position until they enter the tensioned contact position.

The sliding contacts can preferably be arranged next to each other across the longitudinal direction, in particular parallel to each other. At least two, preferably at least three of the adjacent sliding contacts can then advantageously be of different lengths in the longitudinal direction. In this case, the ends of a longer sliding contact can advantageously protrude in the longitudinal direction on both sides beyond the ends of a shorter sliding contact. This ensures that a specific sliding contact is contacted first during retraction and releases contact during extension in order to achieve reliable and the longest possible electrical contact with the corresponding contact element. The first contact with the longest sliding contact can then optionally also be used as an activation signal in order to initiate the subsequent transmission as quickly as possible. The shortest sliding contact can also optionally be used as a signal contact, for example, for starting the transmission since, upon retraction of its contact element, the other sliding contacts have already been contacted by the corresponding contact elements and an electrical connection has been established. Accordingly, this contact element can then also signal this when the contact is released, so that the electrical transmission can be immediately terminated by means of the other sliding contacts. This also effectively prevents sparking between the sliding contacts and the corresponding contact elements.

A contact charging system for transmission of electrical energy and/or data mentioned in the introduction is characterized according to the invention in that the current collector or collectors are designed as described in the claims as well as above and below, and the contact station or contact stations are designed as described in the claims as well as above and below.

An installation mentioned in the introduction is characterized according to the invention in that it includes a contact charging system as described in the claims as well as above and below. In particular, such a contact charging system can be used in the installation. The installation is preferably a high-bay warehouse.

At least one current collector can preferably be arranged on one or several or all electrical consumers as described in the claims as well as above and below. One or several contact stations can also preferably be arranged on the frame part as described in the claims as well as above and below.

In a further modification of the installation, one or several current collectors can preferably be arranged on the frame part as described in the claims as well as above and below. At least one contact station can then preferably be arranged on one or several or all electrical consumers, as described in the claims as well as above and below.

### BRIEF DESCRIPTION OF THE DRAWINGS

Additional details and advantages of the invention will become apparent from the following description of a preferred embodiment with reference to the drawings. In the drawings:

FIG. 1 shows a three-dimensional oblique view of a contact charging system with a contact station and a current collector with contact elements;

FIG. 2 shows a side view of the contact charging system from FIG. 1, from the right in FIG. 1;

FIG. 3 shows a top view of the contact station from FIG. 2;

FIG. 4 shows a three-dimensional oblique view of the current collector from FIG. 1;

FIG. 5 shows a three-dimensional oblique view of the current collector from FIG. 4, from another perspective;

FIG. 6 shows a top view of the current collector from FIG. 1, in the position of FIG. 4;

FIG. 7 shows a front view of the current collector from FIG. 6;

FIG. 8 shows a sectional view through the current collector from FIG. 6, along A-A;

FIG. 9 shows a three-dimensional oblique view of the contact elements from FIG. 4;

FIG. 10 shows a top view of the contact element from FIG. 9;

FIG. 11 shows a front view of the contact element from FIG. 9;

FIG. 12 shows a sectional view through the contact element from FIG. 10, along line B-B;

FIG. 13 shows a side view of a contact element from FIG. 11, from the left in FIG. 11;

FIG. 14 shows a sectional view through the contact element from FIG. 11, along line C-C in eight-fold magnification;

FIG. 15 shows an exploded view of the current collector from FIG. 4;

FIG. 16 shows a front view of an alternative contact element according to FIG. 9;

FIG. 17 shows a schematic three-dimensional bottom view of the contact element from FIG. 16;

FIG. 18 shows a sectional view through part of the contact element from FIG. 16 according to FIG. 12;

FIG. 19 shows a schematic three-dimensional oblique view of a contact pin element of the contact element from FIG. 17.

### DETAILED DESCRIPTION

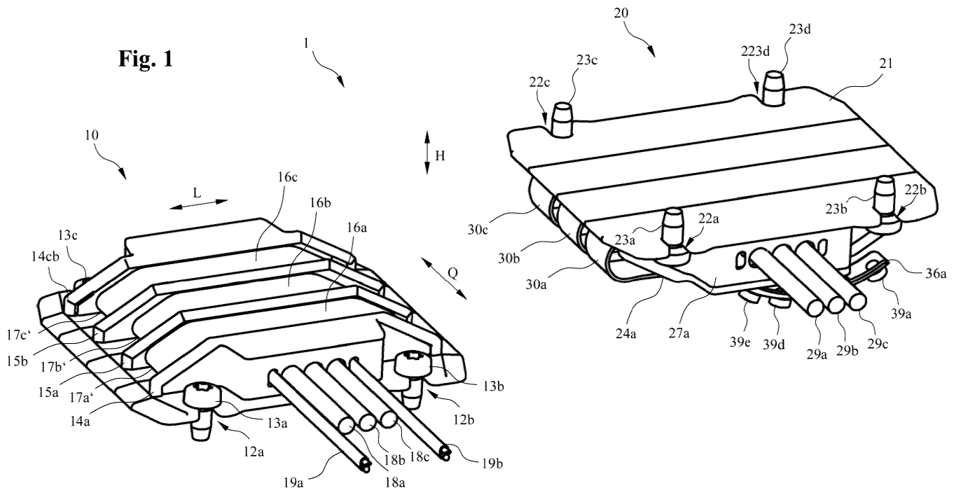

FIG. 1 shows a three-dimensional oblique view of a contact charging system 1 according to the invention with a contact station 10 and a current collector 20 for contacting of contact station 10.

The contact charging system 1 can be used in a variety of technical fields, in which a preferred application lies in the area of automated high-bay warehouses. Individual or all shelf compartments of a high bay can each be provided with one or, if necessary, several contact stations 10. One or, if necessary, several current collectors 20 can be provided as electrical consumers on introducible and removable shelf containers in the shelf compartments in an entry direction or longitudinal direction L. The contact station 10 and the current collector 20 must then be aligned relative to each other so that they electrically contact each other when shelf containers are introduced to the shelf compartment in order to then transfer electrical energy by contact from the contact station 10 via the current collector 20 to electrical consumers on the shelf containers.

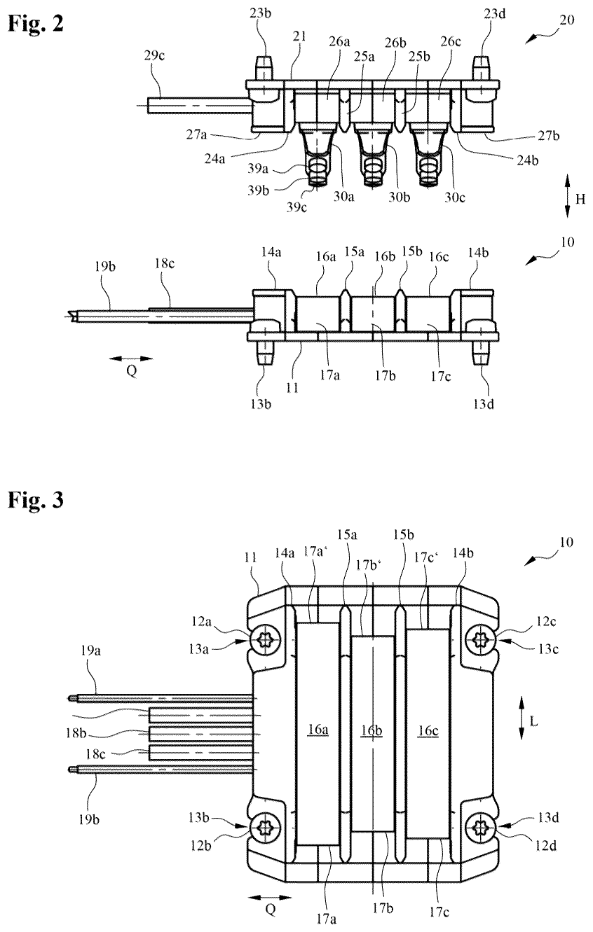

The contact station 10, which is shown in FIG. 2 in a side view, i.e., from the right in FIG. 1, and in a top view in FIG. 3, has a fastening plate 11 which can preferably be made from a non-electrically conductive material, such as plastic. The fastening plate 11 can then be formed in one or several parts and consists of individual parts connectable to each other. In the present embodiment, the fastening plate 11 consists of parts running in the longitudinal direction, in which the separation lines between the parts are clearly visible in FIGS. 2 and 3. This serves to simply production and improve variability, but the fastening plate 11 can also be produced from fewer or more parts or even in one piece.

In order to be able to fasten the contact station 10 onto a support prescribed for this purpose (not shown), for example, to the bottom of a shelf compartment of a high-bay warehouse, four recesses 12a-d are provided on the fastening plate 11 on the sides, through which the fastening plate 11 can be screwed onto the support by means of four fastening screws 12a to 12d. As in the present embodiment, the recesses 12a-d are preferably open on the sides so that the fastening screws 13a and 13b can be pre-mounted in the support and the fastening plate 11 can then be pushed laterally with the recesses 12a and 12b into the fastening screws 13a, 13b. Only one of the fastening screws 13c or 13d then has to be screwed through recess 12c or 12d into the support in order to pre-fasten the fastening plate 11 for final assembly. The last fastening screw 13d can then be screwed into the support without any risk of displacement of the fastening plate 11 on the support and the remaining fastening screws 12a to 12c can then be tightened.

Side walls 14a, 14b and center separators 15a, 15b lying therebetween are arranged on both outer sides of the current collector 20 in a transverse direction Q running across the longitudinal direction L, which extend upward from the fastening plate 11 in the longitudinal direction L and in a height direction H extending across the transverse direction Q and across the longitudinal direction L.

Sliding contacts 16a-c made from an electrically conductive material are provided between the side walls 14a, 14b and the center separators 15a, 15b, which have ramps 17a-c, 17a′-c′ at their ends rising upward in the height direction H from the fastening plate 11. The side walls 14a, 14b and separators 15a, 15b are preferably made from an electrically non-conductive material, for example, plastic or the like, in order to reliably insulate the electrically conductive sliding contacts 16a-c from each other.

The sliding contacts 16a-c are electrically connected, in particular welded or soldered to the contact lines 18a-18c, which are connectable or connected to a power supply of the contact charging system 1.

Sensor lines 19a, 19b are also provided, which are connected, for example, to temperature sensors that detect the temperature of contact 16a, designed as a negative pole, and contact 16c, designed as a positive pole. The sliding contact 16b, on the other hand, serves as a switching contact in order to start charging.

As is apparent from FIG. 3, the three sliding contacts 16a-c are of different lengths and protrude to a different extent in the longitudinal direction L. The first sliding contact 16a is then longest and protrudes in the longitudinal direction L relative to the two other sliding contacts 16b and 16c so that one contact element 30a of the current collector 20 first contacts the sliding contact 16a before additional contact elements 30b, 30c contact the sliding contact 16b or 16c.

Preferably, the middle sliding contact 16b serves as the shortest sliding contact and serves as an enable or trigger pole, to ensure that first the negative pole 16a and then the positive pole 16c have reliable electrical contact with the corresponding contact element 30a or 30c before the charging process is started. Among other things, this prevents sparking due to the sliding contacts 16a, 16c not yet making proper contact with the contact elements 30a, 30c, which would substantially reduce the service life of the contact elements 30a, 30c transmitting the electrical energy and the corresponding sliding contacts 16a, 16c.

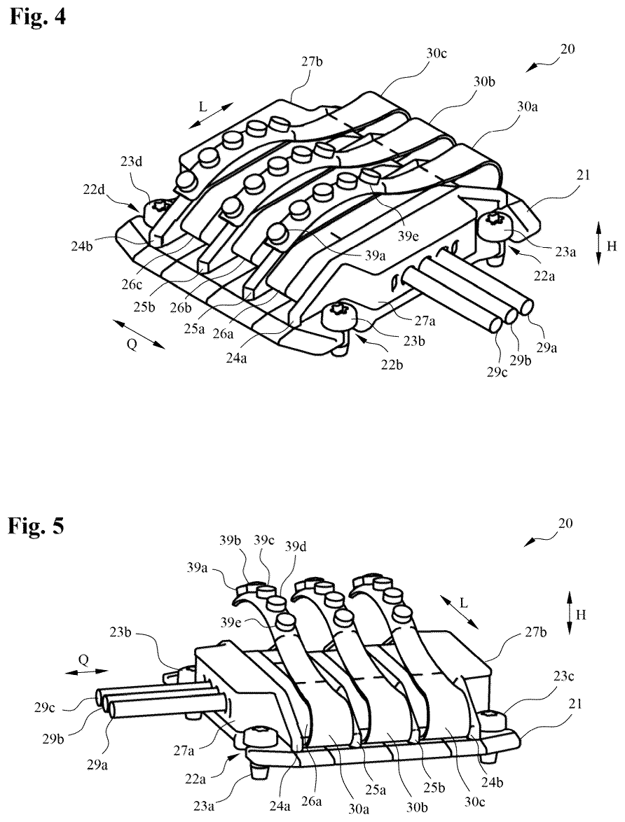

The current collector 20 is shown particularly clearly in FIGS. 4-8 and 15, in addition to the illustrations of the contact charging system 1 in FIGS. 1 and 2. The current collector 20 in FIGS. 1 and 2 is shown in a position relative to the contact station 10, whereas, in FIG. 4 and in the additional FIGS. 5 to 8 derived therefrom, the current collector 20 is shown upside down in order to explain the invention more easily.

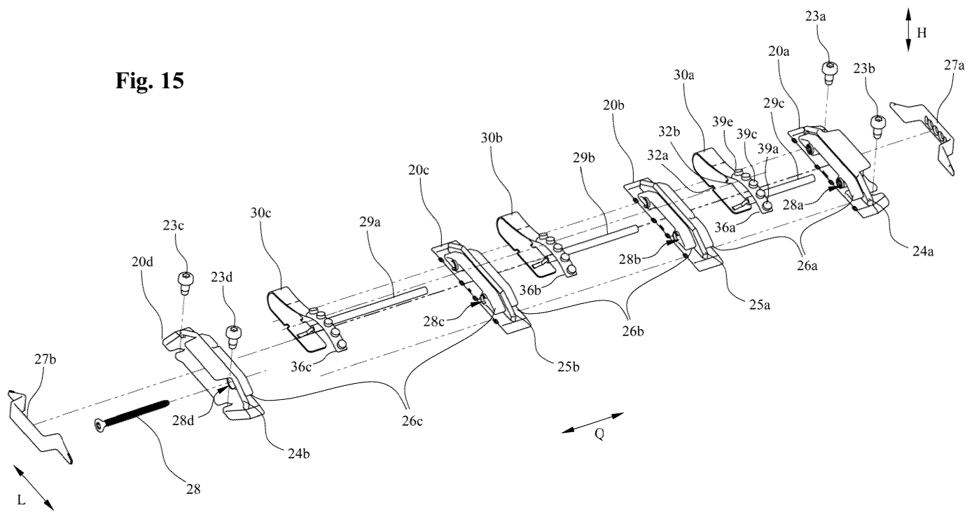

The current collector 20 has a support plate 21, which, as clearly visible in FIG. 1 and FIG. 15, consists of several components arranged next to each other running in the longitudinal direction L, for example, the sections 20a-d shown as examples in FIG. 15. The support plate 21 has recesses 22a-d on the side for fastening screws 23a-d, by means of which the current collector 20 can be fastened to the electrical consumer to be supplied. As in the contact station 10, this is also done accordingly by means of fastening screws 23a-d, so that reference is made to the explanations given above for fastening the fastening plate 11.

The current collector 20 also has side walls 24a, 24b running in the longitudinal direction L and height direction H, as well as center separators 25a, 25b lying therebetween, between which fastening ramps 26a-c are located. The individual sections 20a-d arranged next to each other running in the longitudinal direction L of the support plate 21 are clearly visible in FIG. 15, in which the fastening ramps 26a-c each divided in half are provided on the inside of the side walls 24a, b and the center separators 25a, b. Side walls 27a, 27b are provided on the outside of side walls 24a, 24b, in which openings for contact lines 29a-c are provided in the side wall 27a. In order to connect the individual sections 20a-d of the support plate 21 of the current collector 20 to each other, the sections can be screwed to each other by means of a connecting screw 28 inserted into aligned through openings 28d-b in these sections 20d-b on the right section 20a of fastening ramp 26a in FIG. 15, in which case the latter preferably has an internal thread 28a for this purpose. The internal thread 28a can be introduced, inserted, or cast into the material of the section 20a, in particular if the section 20a is made of plastic. If at least section 20a is made of plastic, a through opening can be provided instead of the internal thread 28a, which is adapted to the diameter of the connecting screw 28 so that the connecting screw 28 can dig into the material of section 20a, thus simplifying manufacture and assembly. The through openings 28b-d can preferably have a greater inside diameter than the connecting screw 28, in order to be able to easily insert the latter and thus facilitate assembly of the current collector 20. The through opening 28b-d, however, can also have a slightly smaller diameter than the connecting screw 28 so that the connecting screw 28 digs into the through openings 28d-b and thereby firmly fastens each section 20b-d. Other connection methods are also conceivable, for example, snap-in connections between the individual sections. The sections 20a-d can also have positioning aids and additional means of connection apart from the connecting screw 28, such as snap-in connections.

The current collector 20 is preferably assembled from the sections 20a-20d, which are clearly visible in FIG. 15, in order to facilitate the assembly and fastening of electrically conductive contact elements 30a-c, which are electrically connected to the contact lines 29a-c. The contact elements 30a-c are designed identically so that the invention will be explained below primarily with reference to contact element 30a. Corresponding explanations apply analogously to the contact elements 30b and 30c.

The contact station 10 can also be constructed in principle like the current collector 20, in particular as shown in FIG. 15, from several sections arranged next to each other and running in the longitudinal direction L.

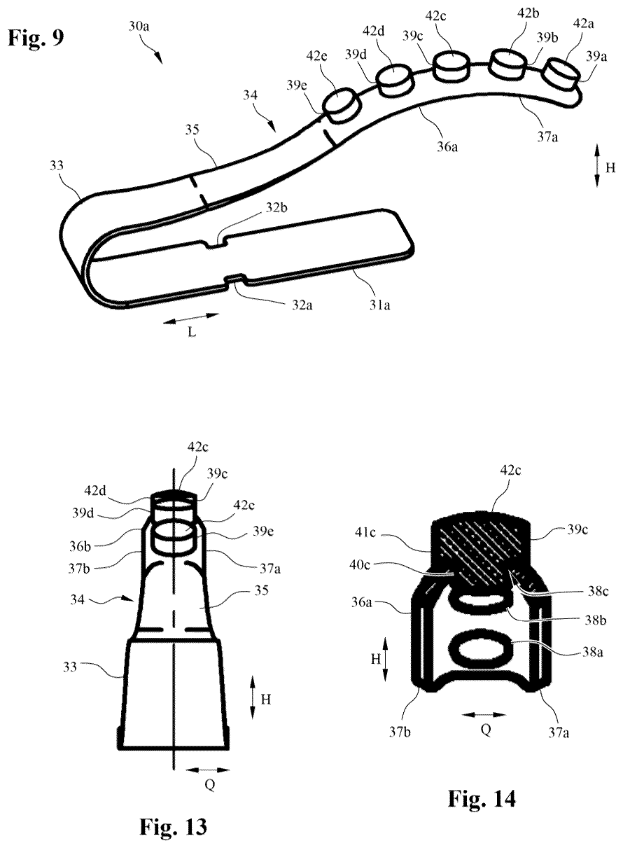

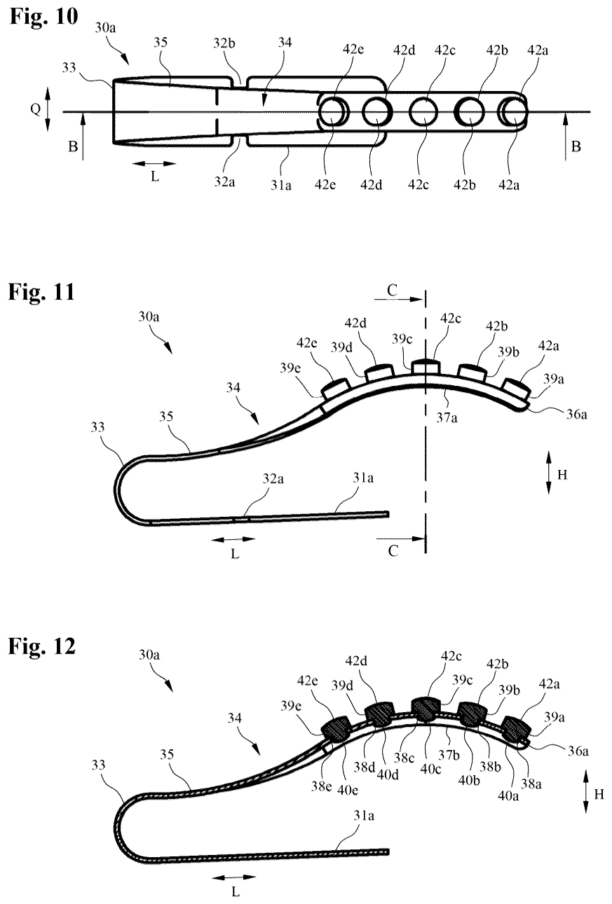

As follows in particular from FIGS. 9 to 14, for the contact element 30a and the exploded view of the current collector 20 in FIG. 15, the contact element 30a is arranged between the two sections 20a, 20d of the support plate 21 and encloses the fastening ramp 26a. Positioning recesses 32a, 32b opposite each other in the transverse direction Q are provided on a fastening section 31a of the contact element 30a, which engage in corresponding positioning pins or protrusions (not visible) on the sections 20a, 20b. In the installed state of support plate 21, these positioning pins or protrusions thus fix the contact element 30a in the longitudinal direction L and on the current collector 20. The contact element 30a is preferably fastened to the support plate 21 so as to be positioned floating thereon, at least in the height direction H, preferably also to a certain extent in the transverse direction Q and/or longitudinal direction L. For this purpose, the positioning recesses 32a, b are configured somewhat larger in the longitudinal direction L than the fixing protrusions of sections 20a, 20b, in order to permit some play in the longitudinal direction L. The fixing protrusions in the transverse direction Q accordingly do not reach the base of the positioning recesses 32a, b in order to be able to allow movement in the transverse direction Q. The contact elements 30b and 30c are also accordingly arranged between the sections 20b and 20c and sections 20c and 20d.

The contact element 30a has a fish hook-like shape, and is particularly apparent in FIGS. 9, 10 and 13, in which a sharply curved section 33 is connected to the fastening section 31a provided for mounting on the support plate 21, in which the contact element 30a is curved downward by 180°. An S-shaped section 34 is then connected to this sharply curved section 33, which initially curves upward, in particular concavely, in a first curved section 35 in the height direction H away from the fastening part 40a, and then curves back in the height direction H toward fastening section 31, in particular convexly, in a contact section 36a designed as a second curved section.

The contact element 30a in fastening section 31a is designed flat or strip-like even in the sharply curved section 33 and in the first curved section 35, whereas the contact section 36a formed as the second curved section is designed trough-like, as clearly visible in FIG. 14.

The trough-like configuration of the contact section 36a with side walls 37a, 37b bent downward toward the fastening section 31a serves to stabilize the contact section 36a. The contact element 30a is intended to be designed for a very large number of contact cycles, preferably at least 1 million contact cycles, more preferably at least 2 million contact cycles. A contact cycle is defined as a single insertion of the contact element 30a into the sliding contact 16a and its complete retraction from the sliding contact 16a.

The contact element 30a preferably consists of an electrically conductive material that preferably has good spring-elastic properties in order to able to be compliant during entry and contacting via the ramp 17a and 17a′ of the sliding contact 16a and to be permanently pressed in the height direction H against the sliding contact 16a, and to make reliable electrical contact therewith. The contact element can advantageously be made of spring steel, but other suitable materials could also be used, such as tin bronze.

A number of pin receptacles 38a-e are provided on the side facing away from the fastening section 31a on the trough-like contact section 36a in the height direction H, as shown in particular by FIGS. 12 and 14. The pin receptacles 38a-e are designed here as holes, but can also have a different shape and configuration, for example, square, hexagonal or polygonal.

An electrically conductive contact designed as a contact pin 39a-e is inserted with its fastening part 40a-e into each of the pin receptacles 38a-e. A mushroom-shaped contact part 41a-e is connected to the fastening part 40a-e, which is therefore wider than the fastening part 40a-e. The contact part 41a-e has a cap-like contact surface on the side facing away from the fastening section 31a in the height direction H, which is designed here as a contact cap 42a-d. However, other configurations of the contact surface can also be used, whereby the configuration as a cap, i.e., as a circular spherical section, enables good contact with the sliding contact 16a, in particular a largely point-like contact. This means that the contact element 30a presses only a small part of the contact pin 39c against the sliding contact 16a in a very concentrated fashion, thereby ensuring good current transmission.

During the charging operation, the contact surface 42c of the center contact pin 39c preferably rests against the sliding contact 16a, in particular at the vertex of contact surface 42a. Furthermore, in the case of a cap-like contact surface 42c, the imaginary connecting line between the vertex and the center point of the sphere defining the cap-like contact surface is perpendicular to the sliding contact 16a or the contact surface thereof.

The cap-like design of the contact surface 42a-e of contact parts 41a-e also makes it possible to compensate for any inclination or tilting of the current collector 20, in particular in the height direction H relative to contact station 10, whereby point-like contact with the sliding contact 16a-c can be ensured.

In the present embodiment, unspecified vertices of the contact surfaces 42a-e follow the curvature of the contact section 36a, which is preferably formed here as a circular arc so that the vertices of the contact surfaces 42a-e also lie on a circular arc. The curvature of the contact section 36a, however, can also have a different course, for example, an elliptical, parabolic, hyperbolic or other curved course.

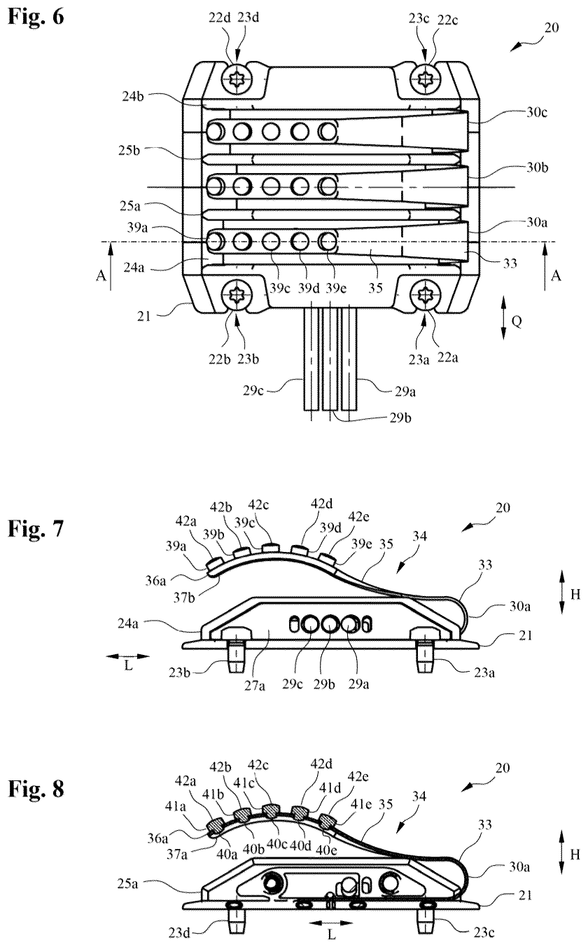

In order to enable a reliable insertion of the contact element 30a-c into the contact station 10 against the sliding contacts 16a-c, even when the movable electrical consumer with the current collector 20 is positioned imprecisely relative to the support and the contact station 10, the contact elements 30a-c taper from the sharply curved section 33 to the contact section 36a via the first curved section 35, as can be clearly seen in particular in FIGS. 6, 10 and 13.

In the present embodiment, the fastening part 40a of the contact pin, as can be seen in FIG. 14, for example, is designed as a rivet, which is fastened in a known manner to the pin receptacle 38a by a riveting process in which the fastening part 40a expands in a known manner by means of external force and therefore becomes wider than the pin receptacle 38a, whereby the contact pin 39a is fastened firmly and in an electrically conductive manner to the contact section 36a. Instead of fastening by rivets, however, other types of fastening can also be used, for example, the fastening part 40a can have external threads and the pin receptacle 38a internal threads, so that the contact pin 39a can be screwed in and, if necessary, unscrewed. The contact pins 39a-e could also be glued, welded or soldered to the contact element 30a in an electrically conductive manner.

The other fastening pins 39b-e are inserted accordingly into the second curved section 36a and fastened there. The same applies for the contact elements 30b, c, which are configured accordingly.

If the current collector 20 enters the contact station 10, as shown in FIG. 1, the contact elements 30a-c contact the sliding contacts 16a-c in the region of their ramps 17a-c and 17a′-c′, respectively. As the current collector 20 moves further in the longitudinal direction L toward contact station 10, the S-shaped curved sections 34 of the contact element 30a are pressed in the height direction toward the current collector 20 and its support plate 21. During entry, the contact section 36a is therefore moved from its relaxed rest position shown in the drawing into a tensioned contact position in the height direction H toward the fastening section 31a. In the contact position, the contact section 36a is permanently pressed against the sliding contact 16a by the spring-elastic properties of the contact element 30a in order to ensure electrical contact. For the sake of clarity, in FIG. 2 the current collector 20 is shown at a considerably greater distance from the contact station 10 in the height direction, whereas, in reality, the current collector 20 is arranged significantly closer to the contact station 10 in the height direction H, in order to enable reliable contact.

Since identically formed contact pins 39a-d follow the curvature line of contact section 36a in the trough-like contact section 36a, when the contact element 30a moves against the sliding contact 16a, the contact pin 39a first contacts the sliding contact 16a, followed by contact with the contact pin 39b and then 39c. Depending on the distance between the current collector 20 and the contact station 10 in the height direction H, a different contact pin 39a-e can also contact the sliding contact 16a with its contact cap 42a-c.

When the current collector 20 exits from the contact station 10 in the longitudinal direction L, the contact pins 39a, b then contact the sliding contact 16a in the region of the ramps, in reverse order to that during retraction, so that contact is ensured until the current collector 20 has completely exited from the contact station 10, and any sparking can be avoided. If necessary, exiting can also occur in the other direction and the current collector 10 then travels “through” the contact station 10 in the longitudinal direction L so that the contact pins 39d, e then reliably contact the sliding contact 16a in the region of the opposite ramp 17a′ until exiting is complete. This can be the case, for example, if the shelf compartment in the high-bay warehouse in which the contact station 10 is fastened can be filled from both sides of the shelf in the longitudinal direction L, i.e., the movable shelf container can therefore exit on both sides.

In an alternative embodiment, the contact element 30a can also be arranged on the contact station 10 and the sliding contact 16a-c on the current collector 20. As in the embodiment shown here, the individual parts forming the fastening plate 11 and the support plate 21 can be formed identically, as can be seen in particular in FIG. 15, in a manner that is advantageous in terms of manufacture and assembly, so that the sliding contact 16a-c can be easily arranged on the fastening ramp 26a-c, while the contact element 30a-c can likewise be easily arranged on the parts of the fastening plate 11 having the ramps 17a-c, 17a′-c′.

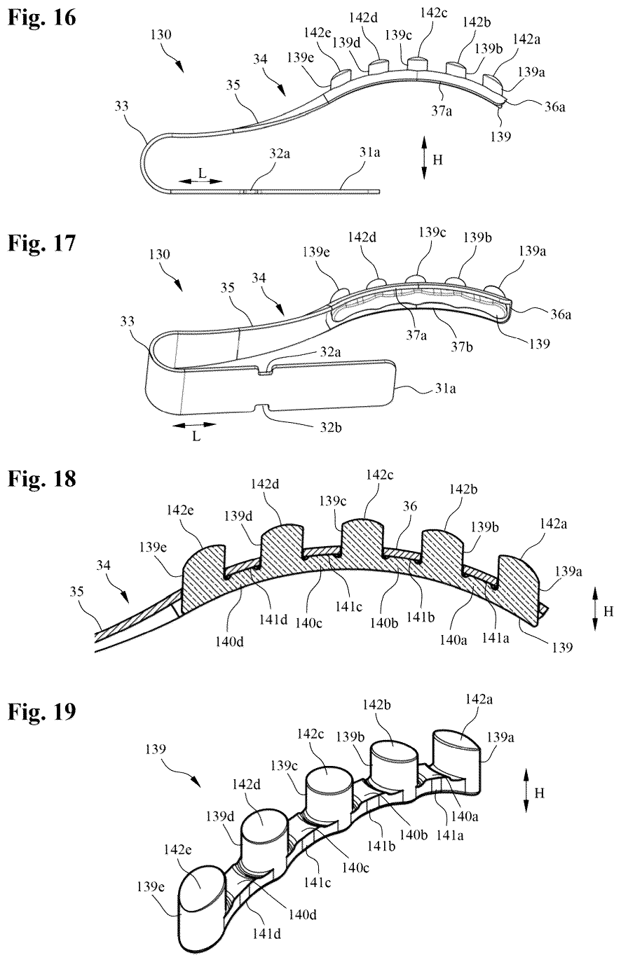

An alternative embodiment of a contact element 130 is shown in FIGS. 16 to 19, in which the configuration of the contact pins 139a-139e differs essentially from the configuration of the contact pins 39a-e of contact element 30 shown in FIGS. 1 to 15. Therefore, what follows is primarily a discussion of the differences, while identical components again bear the same designations and the same reference numbers.

The alternative contact element 130 again has contact pins 139a-e, which, however, are not individually inserted into the contact receptacles 38a-e, but are advantageously connected by connectors 140a-d located between adjacent contact pins 139a-e to a contact pin element 139, which is advantageous from a manufacturing standpoint. The connectors 140a-d have current transmission surfaces 141a-d facing the contact section 36a, which come into contact with the trough bottom of the trough-like contact section 36a and are preferably glued, soldered, welded or otherwise connected electrically conductive, as can be seen clearly in FIG. 18. This ensures good and flat current transmission from the contact pin element 139 to the contact section 36a.

Unlike that shown in FIGS. 12 and 14, the contact surfaces 142a, b, d, e of the contact pins 139a, b, d, e are not formed here at the center relative to the central axis of the corresponding contact cap, but off-center. The contact surfaces 142a, b, d, e then roughly follow the concave curvature of the second curved section 36a; the edges of the contact surfaces 142a, b, d, e facing away from the center contact 139c are located closer to the fastening section 31a, as seen in the height direction H, than the edges of the contact surfaces 142a, b, d, e facing the contact pin 139c.

This is done, among other things, so that the contact pins 139a, b, d, e can move more smoothly against the sliding contact 16a, since the contact surfaces 142a, b, d, e already come into contact with sliding contact 16a in the area of its rounded surface and not with the edge at the transition to the cylindrical part of contact parts 141a, b, d, e. This configuration can also be provided for the contact surface 42a-e of the contact element 30 described above.

In addition, manufacture of the contact element 130 can also be simplified, since the contact receptacles 138a-e through which the contact pins 139a-e are inserted can all run in the same insertion direction from the contact element 130, in particular if they are formed as holes. The insertion direction preferably runs parallel to the height direction H. However, as in the first embodiment of the contact element 30 described above, the vertices of the preferably cap-like contact surfaces 142a-e then again follow the curvature of the contact section 36a and lie in particular on a circular arc.

The alternative contact element 130 can therefore be easily and quickly produced, and exhibits good and large-surface current transmission.

### REFERENCE NUMERALS

1 Contact charging system
10 Contact station, charging station
11 Fastening plate
12a-d Recess for fastening screws
13a-d Fastening screws
14a, b Side walls
15a, b Center separator
16a-c Sliding contact (negative pole 16a, trigger pole 16b, plus pole 16c)
17a-c, 17a′-c′ Ends
18a-c Contact lines
19a, b Sensor lines
20 Current collector
20a-d Individual sections for current collector
21 Support plate
22a-d Recesses for fastening screws
23a-d Fastening screws
24a, b Side walls
25a, b Center separator
26a-c Fastening ramps
27a,b Side panels
28 Connecting screw
28a Inside thread in section 20a for connecting screw 28
28b-d Through opening for sections 20b-d
29a-c Contact lines
30a-c Contact elements
31a-c Fastening section
32a, b Positioning recesses
33 Sharply curved section, restoring element
34 S-shaped bent section
35 First curved section
36a-c Trough-like second curved section, contact section
37a, b Side walls of contact section
38a-e Contact receptacles, pin receptacles, holes
39a-e Contacts, contact pins
40a-e Fastening parts
41a-e Contact parts
42a-e Contact caps, cap-like contact surface
130 Alternative contact element
138a-e Contact receptacles, pin receptacles, holes
139 Contact pin element
139a-e Contacts, contact pins
140a-d Connectors
141a-d Current transmission surfaces, connectors
142a-e Contact caps, cap-like contact surface
L Plug-in direction, longitudinal direction, sliding contacts
Q Transverse direction
H Height direction

1. A contact element for contacting a sliding contact, the contact element including a fastening section and a contact section extending in a longitudinal direction connected thereto, wherein the sliding contact and the contact element are movable relative to each other, in particular in the longitudinal direction, wherein the contact section has at least one electrically conductive contact with a contact surface for electrically conductive contacting of the sliding contact.

2. The contact element according to claim 1, wherein the contact section is electrically conductive and/or convexly curved.

3. The contact element according to claim 1, wherein the contact section has trough-like side walls at least partially facing away from the contact surface, and wherein the trough-like side walls run substantially in the longitudinal direction.

4. The contact element according to claim 1, wherein the contact section has a free end, and wherein the contact section tapers toward the free end, wherein, in particular, the contact section tapers toward the free end.

5. The contact element according to claim 1, wherein the fastening section runs in the longitudinal direction, and/or wherein the fastening section has positioning recesses and/or positioning protrusions running in a transverse direction extending across the longitudinal direction.

6. The contact element according to claim 1, wherein a sharply curved section, preferably by at least 150°, more preferably by at least 170°, is connected to the fastening section in the longitudinal direction.

7. The contact element according to claim 1, wherein the contact is positioned relative to the fastening section in a rest position and, during deflection of the contact section from the rest position, a restoring force, in particular a spring-elastic force, is exerted on the contact section in the direction of the rest position.

8. The contact element according to claim 1, wherein a first curvature section preferably tapering toward the contact section is connected to the contact section in the longitudinal direction.

9. The contact element according to claim 8, wherein the first curvature section is curved opposite to the contact section in the height direction.

10. The contact element according to claim 7, wherein a first curvature section preferably tapering toward the contact section is connected to the contact section in the longitudinal direction and wherein the first curvature section is connected to the sharply curved section in the longitudinal direction.

11. The contact element according to claim 1, wherein the contact surface of the contact is formed cap-like, in particular in the form of a spherical cap.

12. The contact element according to claim 1, wherein the contact has a contact part, in particular a mushroom-shaped contact part, having the contact surface.

13. The contact element according to claim 1, wherein the contact has a fastening part for fastening into a correspondingly shaped contact receptacle of the contact section.

14. The contact element according to claim 1, wherein several contacts, especially formed as contact pins offset relative to each other in the longitudinal direction, are fastened on the contact section.

15. The contact element according to claim 14, wherein the contacts follow the course of the contact section and/or are arranged at an angle relative to each other in the height direction, and/or wherein vertices of the contact surfaces follow the curvature of the contact section and/or lie on a circular arc.

16. The contact element according to claim 15, wherein several or all of the offset contacts are electrically connected to each other and/or mechanically connected to a contact pin element, wherein preferably
the contact element is adjusted to the curvature of the contact section,
the contacts are connected to each other via connectors, wherein the connectors have current transmission surfaces preferably facing the contact section, preferably surface contact against the contact section, and/or
the contact pin element is formed in one piece with the contacts.

17. A current collector for conductive transmission of electrical energy and/or data to or from a contact station, wherein the current collector has at least one contact element according to claim 1.

18. The current collector according to claim 17, wherein:
the contact elements are arranged next to each other, in particular parallel, across the longitudinal direction,
the contact elements are positioned floating on the current collector, in particular floating in the longitudinal direction and/or the height direction and/or a transverse direction running across the longitudinal direction and/or across the height direction, and/or
the contact elements are arranged on a support plate of the current collector, wherein electrically insulating separators are provided between the contact elements, the support plate preferably being assembled from individual parts connectable to each other in the transverse direction and running in the longitudinal direction.

19. The contact station for conductive transmission of electrical power and/or data to or from a current collector according to claim 18, wherein the contact station has one or more sliding contacts for contacting one or several contact elements of the current collector.

20. The contact station according to claim 19, wherein
the sliding contact or contacts have ramp-like ends running in the height direction opposite each other in the longitudinal direction, and/or
wherein the sliding contacts are arranged next to each other, in particular parallel across the longitudinal direction, wherein preferably at least two, preferably at least three of the adjacent sliding contacts have different lengths in the longitudinal direction, in particular wherein the ends of a longer sliding contact extend in the longitudinal direction beyond the ends of a shorter sliding contact on both sides.

21. A contact charging system for transmission of electrical energy and/or data between at least one contact station and at least one current collector, wherein the at least one current collector is designed according to claim 17.

22. An installation having at least one electrical consumer movable relative to a frame part of the installation, wherein the installation has at least one contact charging system according to claim 21, wherein at least one current collector is arranged on one or several or all of the electrical consumers and/or wherein one or more contact stations are arranged on the frame part or wherein one or several current collectors are arranged on the frame part, and/or wherein at least one contact station is arranged on the one or several or all of the electrical consumers.
